(19) United States
(12) Patent Application Publication
(10) Pub. No.: US 2026/0368634 A1
(43) Pub. Date: Nov. 19, 2026

(54) INFORMATION PROCESSING APPARATUS, INFORMATION PROCESSING METHOD, AND PROGRAM

(71) Applicant: NEC CORPORATION, Tokyo (JP)

(72) Inventor: Yuzuru OKAJIMA, Tokyo (JP)

(73) Assignee: NEC CORPORATION, Tokyo (JP)

(21) Appl. No.: 19/487,727

(22) PCT Filed: Jun. 16, 2023
(86) PCT No.: PCT/JP2023/022354

§ 371 Date: Nov. 25, 2025

(51) Int. Cl. G06N 20/00

(52) U.S. Cl. CPC G06N 20/00

(57) ABSTRACT

An information processing apparatus 100 of the present disclosure includes a case generation unit 121 that generates a virtual case so as to satisfy a constraint set in advance for a part of data included in a case, a prediction unit 122 that performs prediction set in advance for the virtual case, and an evaluation unit 123 that evaluates a condition set for data different from the data applicable to the constraint included in the virtual case, on the basis of the prediction for the virtual case. Therefore, the information processing apparatus 100 is able to support decision making by the user.

### TECHNICAL FIELD

The present disclosure relates to an information processing apparatus, an information processing method, and a program.

### BACKGROUND ART

Prediction based on input data using a machine learning model is performed in various fields. In this context, Patent Literature 1 describes evaluation of a machine learning model. Specifically, Patent Literature 1 calculates an evaluation value when the parameters of a machine learning model are changed.

### CITATION LIST

### Patent Literature

Patent Literature 1: JP 2022-068690 A

### SUMMARY OF INVENTION

### Technical Problem

However, although the technique in Patent Literature 1 evaluates a machine learning model, it cannot evaluate input data for prediction by the machine learning model. That is, when performing prediction for input data using a machine learning model, it is impossible to evaluate how to improve the input data in order to obtain a desired prediction result from the given input data. This causes a problem that effective utilization of a machine learning model cannot be achieved.

Therefore, an object of the present disclosure is to solve the aforementioned problem, that is, it is impossible to effectively utilize a machine learning model for performing prediction for input data.

### Solution to Problem

An information processing apparatus, according to one aspect of the present disclosure, is configured to include
a case generation unit that generates a virtual case so as to satisfy a constraint set in advance for a part of attributes included in a case,
a prediction unit that performs prediction set in advance for the virtual case, and
an evaluation unit that evaluates a condition set for an attribute different from the part of the attributes applicable to the constraint included in the virtual case, on the basis of the prediction for the virtual case.

Further, an information processing method, according to one aspect of the present disclosure, is configured to include
generating a virtual case so as to satisfy a constraint set in advance for a part of attributes included in a case,
performing prediction set in advance for the virtual case, and
evaluating a condition set for an attribute different from the part of the attributes applicable to the constraint included in the virtual case, on a basis of the prediction for the virtual case.

Further, a program, according to one aspect of the present disclosure, is configured to cause a computer to execute processing to
generate a virtual case so as to satisfy a constraint set in advance for a part of attributes included in a case,
perform prediction set in advance for the virtual case, and
evaluate a condition set for an attribute different from the part of the attributes applicable to the constraint included in the virtual case, on a basis of the prediction for the virtual case.

### Advantageous Effects of Invention

The present disclosure, configured as described above, can effectively utilize a machine learning model for performing prediction for input data.

### BRIEF DESCRIPTION OF DRAWINGS

FIG. 1 is a block diagram illustrating a configuration of a first information processing apparatus according to the present disclosure.

FIG. 2 is a diagram illustrating a state of processing performed by the first information processing apparatus according to the present disclosure.

FIG. 3 is a diagram illustrating a state of processing performed by the first information processing apparatus according to the present disclosure.

FIG. 4 is a diagram illustrating a state of processing performed by the first information processing apparatus according to the present disclosure.

FIG. 5 is a flowchart illustrating a processing operation of the first information processing apparatus according to the present disclosure.

FIG. 6 is a diagram explaining an example of use of a second information processing apparatus according to the present disclosure.

FIG. 7 is a diagram explaining an example of use of the second information processing apparatus according to the present disclosure.

FIG. 8 is a block diagram illustrating a hardware configuration of a third information processing apparatus according to the present disclosure. FIG. 9 is a block diagram illustrating a configuration of the third information processing apparatus according to the present disclosure.

### DESCRIPTION OF EXAMPLE EMBODIMENTS

### First Example Embodiment

The present disclosure will be described with reference to the drawings. Note that the drawings may be associated with any of the example embodiments.

### Configuration

An information processing apparatus 10 in the present embodiment is used to perform prediction for input data using a predictive model that is a machine learning model. In particular, the information processing apparatus 10 is used to evaluate improvements in input data so that a desired prediction result can be obtained from the predictive model. For example, in the present embodiment, a predictive model will be explained with a case where it predicts the probability of obtaining a loan, such as a mortgage loan, in a loan screening based on the attributes of a subject. The information processing apparatus 10 can be used to predict the loan approval probability using a predictive model based on the attributes of the subject and further output the conditions necessary to make the loan possible.

However, the machine learning model used by the information processing apparatus 10 for prediction is not necessarily limited to prediction of the aforementioned loan approval probability and may be used for any type of prediction. Therefore, the information processing apparatus 10 can be used to evaluate improvements in any kind of input data.

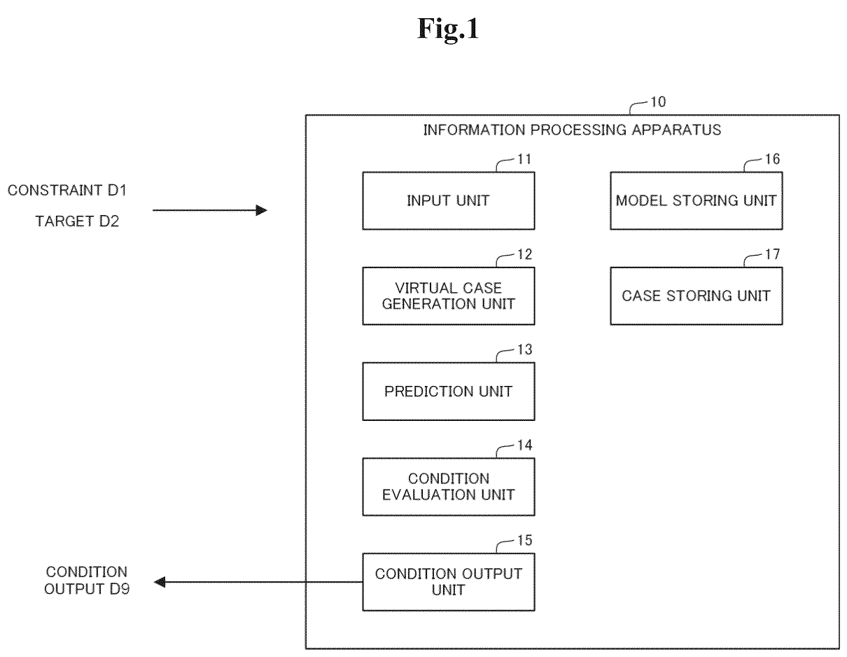

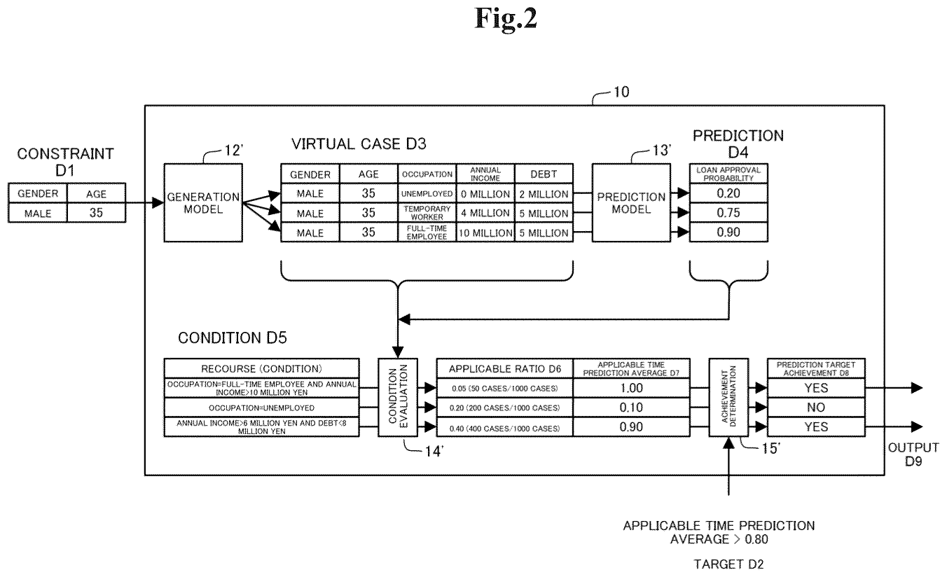

The information processing apparatus 10 is configured of one or more information processing apparatuses each including an arithmetic logic unit and a memory unit. As illustrated in FIG. 1, the information processing apparatus 10 includes an input unit 11, a virtual case generation unit 12, a prediction unit 13, a condition evaluation unit 14, and a condition output unit 15. The functions of the input unit 11, the virtual case generation unit 12, the prediction unit 13, the condition evaluation unit 14, and the condition output unit 15 can be realized by the arithmetic logic unit executing programs for implementing each function stored in the storage device. The information processing apparatus 10 also includes a model storing unit 16 and a case storing unit 17. The model storing unit 16 and the case storing unit 17 are configured of the storage devices. The respective components will be described in detail below. FIG. 2 illustrates a flow of data and a state of processing in the information processing apparatus 10.

The input unit 11 accepts an input of a “constraint” D1 related to some data (attributes) among the input data that serves as a case. Here, the input data serving as a case in the present embodiment includes a plurality of attributes of a subject undergoing a loan screening, and examples of the attributes are “gender, age, occupation, annual income, and debt”. In this case, some attributes serve as “constraints”. In the present embodiment, as illustrated in FIG. 2, “gender and age” are set as “constraints” D1, and specifically, the case where the constraints are “gender: male, age: 35 years” is taken as an example for explanation.

As will be described later, the input unit 11 also accepts an input of a “target” D2 that should be achieved by the prediction for the input data that is a case. For example, in the present embodiment, as illustrated in FIG. 2, as a target of a loan approval probability that should be achieved, a loan approval probability having the possibility of loan approval of 80% (0.8) is accepted as the target D2. The target D2 is to be used in an achievement determination process 15′. Note that the input unit 11 may also accept an input of a target value for each case (for example, loan approval probability>0.70) when performing prediction for a virtual case as described later.

The virtual case generation unit 12 (case generation unit) generates input data that is a virtual case D3 satisfying the constraint D1 on the basis of the “constraint” D1 input as described above. That is, in the case of the present embodiment, the virtual case D3 that satisfies the constraints “gender: male, age: 35” as attributes of the subject, while other attributes “occupation, annual income, and debt” take arbitrary values, is generated. At this time, as illustrated in FIG. 2, the virtual case generation unit 12 uses a generation model 12′ created using input data that is an actual case and is stored in the model storing unit 16 to generate a plurality of virtual cases D3, and stores them in the case storing unit 17. For example, as described below, when there are a plurality of variables, the virtual case generation unit 12 predicts a conditional probability distribution of the remaining variables (occupation, annual income, debt) based on specific variables (constraints: gender, age) as conditions, and samples values according to the distribution to generate a plurality of virtual case.

P(occupation, annual income, debt|gender=male, age=35)

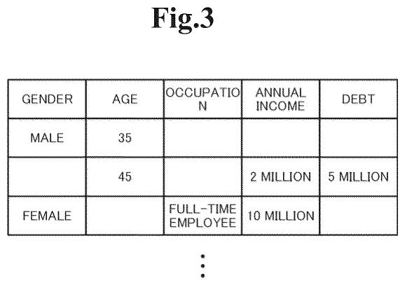

As a more concrete example, as illustrated in FIG. 3, the virtual case generation unit 12 masks some parts (leaves blanks) of a table representing the attributes of the subject, uses the unmasked parts as conditions, predicts the conditional probability distribution of the masked parts, and samples values according to the distribution, to thereby generate a virtual case in which the values of the masked parts are complemented. At this time, by training a machine learning model using a single neural network that outputs probability distributions for arbitrary combinations as the generation model 12′, it becomes possible to easily generate a virtual case with a single model. That is, it is preferable that the generation model 12′ is pretrained to generate values of other explanatory variables when one or more explanatory variables (constraints) are set. For example, it can be realized by a method such as VAEAC (VAE arbitrary conditioning), ACFlow, or ACE.

By generating the virtual case D3 as described above, it is possible to create a case lacking in the actual cases. That is, by generating a virtual case not corresponding to the actual cases, the reliability of improvements in input data is enhanced as described later.

As described above, the prediction unit 13 performs predetermined prediction for the generated virtual case D3. In the present embodiment, as illustrated in FIG. 2, the prediction unit 13 outputs a loan approval probability that is a prediction D4 for the virtual case D3 by using a prediction model 13′ generated using input data that is actual cases and the loan approval results thereof and stored in the model storing unit 16.

The condition evaluation unit 14 (evaluation unit) evaluates “conditions” set for the data different from the constraints included in the aforementioned virtual case D3, on the basis of the prediction D4 for the virtual case D3. That is, as illustrated in FIG. 2, the condition evaluation unit 14 acquires a “condition” D5 (recourse) set by one or a combination of data such as “occupation, annual income, debt” other than the constraints “gender: male, age 35”, in the virtual case D3, and performs a condition evaluation process 14′ to evaluate the “condition” D5 on the basis of the prediction D4. Here, examples of “condition” D5 include “occupation=full-time employee AND annual income>10 million yen”, “occupation=unemployed”, and “annual income>6 million yen AND debt<8 million yen”, as illustrated in FIG. 2.

At this time, the condition evaluation unit 14 may acquire the “condition” D5 by various methods. For example, the condition evaluation unit 14 may use a value of each data randomly selected from the training data that is actual case, as a condition. Also, the condition evaluation unit 14 may learn a random forest using a combination of the virtual case D3 mentioned above and a flag indicating that a pre-set target value (for example, loan approval probability>0.70) for each case for the prediction D4 has been achieved, represented as (x, y), and extract each path of the decision trees contained in the random forest as the “condition” D5. The “condition” D5 may be generated by any method, and may also be acquired from another device.

Here, an example of a method of generating the “condition” D5 by the condition evaluation unit 14 will be further explained. The condition evaluation unit 14 may randomly generate an atomic condition that is a simple form of a condition not including “AND”, such as “feature 1>X”. For example, the condition evaluation unit 14 generates an atomic condition by randomly selecting one data item that can be set to be the condition D5 as a feature, randomly selecting a relational operator, and then randomly selecting a threshold X. Additionally, the condition evaluation unit 14 may generate a composite condition by combining a plurality of atomic conditions, for example, combining them with AND.

Then, as illustrated in FIG. 2, in the condition evaluation process 14′, for each condition D5, the condition evaluation unit 14 calculates an applicable ratio D6 and an applicable time prediction average D7. Here, the applicable ratio D6 represents the ratio of virtual cases that satisfy the condition D5 among all virtual cases D3. For example, when there are 1,000 virtual cases D3 and 50 cases of them satisfy a certain condition D5, the applicable ratio D6 is 50 cases/1,000 cases=0.05. The applicable time prediction average D7 represents the statistical quantity of the loan approval probability that is the prediction D4 of the virtual case D3 satisfying the condition D5. In the present embodiment, the statistical quantity is assumed to be an average value. For example, by summing the loan approval probabilities that are the predictions D4 of the respective virtual cases D3 satisfying the condition D5, and dividing them by the number of the applicable virtual cases D3, the applicable time prediction average D7 is calculated. Note that the applicable time prediction average D7 is not limited to an average value of the loan approval probabilities that are the predictions D4 of the virtual cases D3 satisfying the condition D5; it may be any statistical value calculated from such prediction D4 values, such as the mode of the predictions D4 of the virtual cases D3 satisfying the condition D5.

As illustrated in FIG. 2, the condition evaluation unit 14 evaluates each condition D5 based on the applicable ratio D6 and the applicable time prediction average D7 calculated as described above. At this time, the condition evaluation unit 14 performs an achievement determination process 15′ to determine whether or not the prediction average D7 meets the “target” D2 when the target D2 that should be achieved by the prediction result is input as described above, and applies a prediction target achievement flag (YES) to the condition D5 that meets it and outputs D9 the condition to which the flag is applied. For example, when the target D2 is set as “applicable time prediction average>0.80”, the condition D5 where the applicable time prediction average D7 exceeds the target D2 is output. At this time, the condition evaluation unit 14 may further evaluate the applicable condition D5 more highly as the value of the prediction average D7 is higher. For example, when a plurality of conditions D5 meet the target D2, it is acceptable to select and output only the condition D5 with the highest value of the applicable time prediction average D7. Additionally, the condition evaluation unit 14 may evaluate the applicable condition D5 more highly as the applicable time prediction average D7 and the applicable ratio D6 are higher. For example, when there are a plurality of conditions D5 in which the applicable time prediction averages D7 have almost the same values, the condition D5 with a higher applicable ratio D6 may be evaluated more highly. It is also acceptable to set weights for the applicable time prediction average D7 and the applicable ratio D6 respectively, calculate statistical values between the applicable time prediction average D7 and the applicable ratio D6 in consideration of the weights, and evaluate the applicable condition D5 higher as the statistical value is higher.

Here, the condition evaluation unit 14 (condition generation unit) may exploratorily generate and obtain the “condition” D5 by taking into account the applicable ratio D6 and the applicable time prediction average D7 described above. At this time, the condition evaluation unit 14 may generate the condition D5 so that either one or both of the applicable ratio D6 and the applicable time prediction average D7 increase. That is, the condition evaluation unit 14 calculates the applicable ratio D6 and the applicable time prediction average D7 for each of a plurality of complex conditions randomly generated as described above, and generates the condition D5 that results in one or both being high. As a more specific example, first, complex conditions generated randomly are placed in a list. Then, among the complex conditions included in the list, a complex condition in which the applicable ratio D6 and the applicable time prediction average D7 are high is extracted. Furthermore, by replacing a part of the extracted complex condition with a newly randomly generated atomic condition, a new complex condition is generated and placed in the list. Then, by repeating this process until the list exceeds a predetermined threshold, it is possible to generate conditions. Note that the process of extracting a complex condition in which both the applicable ratio D6 and the applicable time prediction average D7 are high can be realized by selecting a complex condition that is not Pareto dominated by other complex conditions.

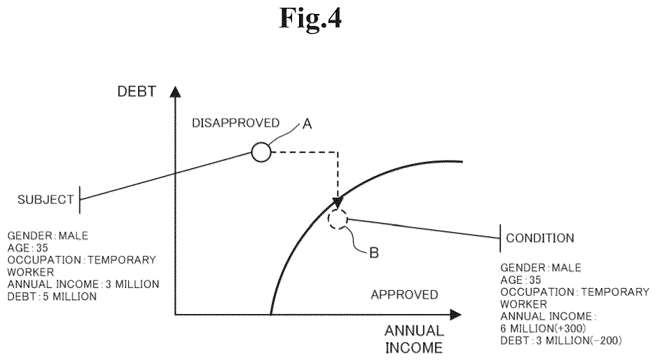

As described above, the condition output unit 15 outputs the highly evaluated condition D5. For example, the condition output unit 15 outputs the condition D5 that is most highly evaluated among the conditions D5 satisfying the constraint D1 in the attributes of the subject for whom prediction of the loan approval probability is requested. Here, an example of an output by the condition output unit 15 is illustrated in FIG. 4. FIG. 4 graphically illustrates the condition D5 for the “annual income and debt” on a coordinate plane where the vertical and horizontal axes represent “annual income and debt”, satisfying the constraints DI (gender: male, age: 35) and meeting the target D2 that is the applicable time prediction average. At this time, when the actual case of the subject, that is, “gender: male, age: 35, occupation: temporary worker, annual income: 3 million yen, debt: 5 million yen” is input as input data and the predicted loan approval probability using the prediction model 13′ is lower than the target D2 and thus disapproved, as illustrated in FIG. 4, information A of the subject is displayed in the disapproval region on the coordinate plane, along with information B having the best evaluated conditions satisfying the same constraints as the subject, that is, “gender: male, age: 35, occupation: temporary worker, annual income: 6 million yen, debt: 3 million yen”. At this time, it is better to display the differences between the subject's information A and the condition information B, that is “annual income: 6 million (+3 million), debt 3 million (−2 million)”.

As a result, the subject can know how to improve the own attributes. At this time, since the output conditions are based on the virtual case determined to have good evaluation, the reliability is also high. As a result, it is possible to effectively utilize the prediction model.

### Operation

Next, operation of the information processing apparatus 10 described above will be explained. Here, as an example, a case of evaluating the conditions under which a loan is approved is explained, in a situation of predicting the probability of approval of a loan such as a mortgage loan on the basis of the attributes of the subject as described above.

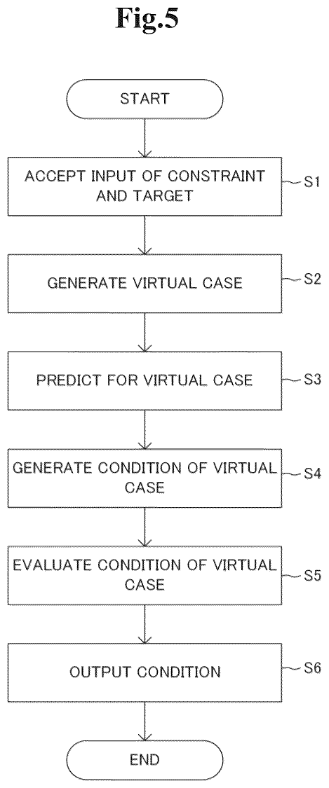

The information processing apparatus 10 receives an input of the “constraint” D1 regarding some attributes among the input data used as a case (step S1 in FIG. 5). For example, in the present embodiment, among the attributes of the subject such as “gender, age, occupation, annual income, debt”, “gender=male, age=35 years” are accepted as the “constraints” D1 as illustrated in FIG. 2. The information processing apparatus 10 also accepts an input of the “target” D2 that should be achieved by the prediction (step S1 in FIG. 5). For example, in the present embodiment, as illustrated in FIG. 2, as a target that should be achieved by a loan approval provability, a loan approval probability in which the possibility of loan approval is 80% (0.8) is accepted as the target D2.

Then, the information processing apparatus 10 generates the virtual case D3 that satisfies the constraints D1 (step S2 in FIG. 5). In the present embodiment, as illustrated in FIG. 2, a generation model 12′ generated using input data that is actual cases is used to generate a plurality of virtual cases D3. For example, as illustrated in FIG. 2, constraints such as “gender=male, age=35” are set, and values for other attributes such as “occupation, annual income, and debt” are sampled from a probability distribution conditioned on these constraints to generate a plurality of virtual cases.

Then, the information processing apparatus 10 performs prediction for the generated virtual case D3 (step S3 in FIG. 5). In the present embodiment, as illustrated in FIG. 2, a prediction model 13′ generated using input data that is actual cases and the loan approval results thereof is used to output a loan approval probability that is the prediction D4 for the virtual case D3.

Then, the information processing apparatus 10 generates the condition D5 set for attributes different from the constraints included in the virtual case D3 (step S4 in FIG. 5). In the present embodiment, as illustrated in FIG. 2, the “condition” D5 (recourse) is generated based on one or a combination of attributes among “occupation, annual income, and debt” other than the constraints “gender: male, age 35” in the virtual case D3. The information processing apparatus 10 may obtain the condition D5 set in advance or may obtain the condition D5 generated by another device or the like.

Then, the information processing apparatus 10 evaluates the generated condition D5 based on the prediction D4 (step S5 in FIG. 5). In the present embodiment, the information processing apparatus 10 calculates the applicable ratio D6 and the applicable time prediction average D7 for each condition D5. Here, the applicable ratio D6 represents the ratio of virtual cases satisfying the condition D5 out of all virtual cases D3. Also, the applicable time prediction average D7 represents a statistical quantity of the loan approval probability that is the prediction D4 of the virtual case D3 satisfying the condition D5, and in the present embodiment, the statistical quantity is assumed to be an average value.

Then, as illustrated in FIG. 2, the information processing apparatus 10 evaluates the condition D5 that meets the target D2 of the loan approval probability in which the applicable time prediction average D7 is input in advance, and outputs the highly evaluated condition D5 (step S6 in FIG. 5). At this time, the information processing apparatus 10 highly evaluates the condition as the values of the applicable ratio D6 and the applicable time prediction average D7 are higher, and for example, outputs the condition D5 having the highest evaluation.

Then, when attributes of a subject requesting prediction of loan approval probability are input, the information processing apparatus 10 predicts the loan approval probability based on the attributes of the subject. At this time, as illustrated in FIG. 4, the information processing apparatus 10 outputs information A of a prediction result of the attributes of the subject and information B of the condition meeting the constraints and having the highest evaluation. As a result, the subject can understand how to improve the own attributes. At this time, since the output condition is based on the virtual case determined to have good evaluation, the reliability thereof is also high. As a result, the predictive model can be effectively utilized, and it can also promote better decision-making by the subject.

### Second Example Embodiment

Next, a second example embodiment of the present disclosure will be described with reference to the drawings. In the present embodiment, an example of using the information processing apparatus, described in the above embodiment, in the medical care and healthcare field is shown.

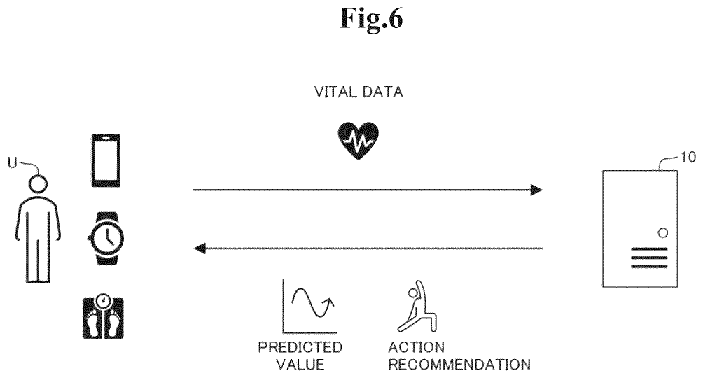

As illustrated in FIG. 6, in the present embodiment, a subject U inputs the own characteristic data (for example, gender, age) along with vital data (for example, weight, walking time) and the like into the information processing apparatus 10 via a network, and the information processing apparatus 10 predicts values representing the health condition such as blood pressure of the subject U. In this case, the information processing apparatus 10 sets the characteristic data of the subject U as the constraints described above, and generates a virtual case in which various values are set to the vital data. Then, the information processing apparatus 10 generates conditions consisting of data other than the constraints in the virtual case, and evaluates the conditions. At this time, among the conditions of the virtual case satisfying the constraints, the information processing apparatus 10 highly evaluates a condition that meets the target that a blood pressure value is not high and is appropriate.

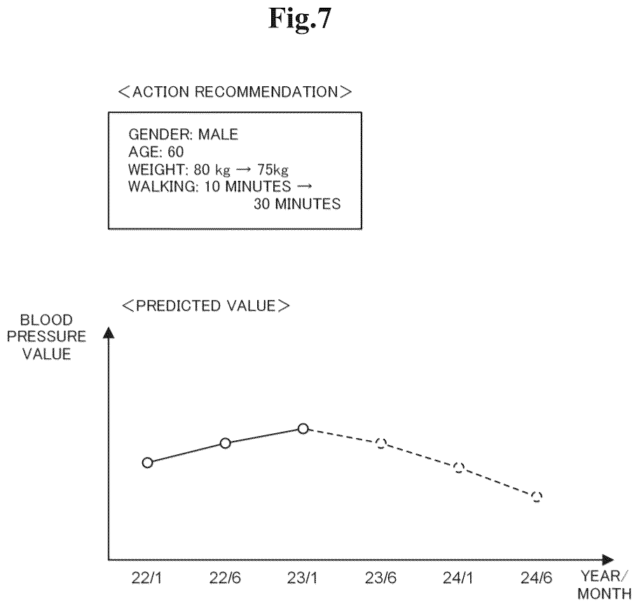

Then, as illustrated in FIG. 6, the information processing apparatus 10 outputs an action recommendation consisting of vital data that could result in conditions for improving the current blood pressure value and achieving the target for the subject U, and also outputs a predicted future blood pressure value that serves as the target. As one example, as illustrated in FIG. 7, the information processing apparatus 10 outputs, as an action recommendation, conditions (weight: 80 kg→75 kg, walking time: 10 minutes→30 minutes) and outputs chronological transition of the predicted blood pressure value.

The usage example of the information processing apparatus 10 described above is merely one example, and it may be used for carrying out any kind of prediction.

### Third Example Embodiment

Next, a third example embodiment of the present disclosure will be described with reference to the drawings. In the present embodiment, the outline of the configuration of the information processing apparatus explained in the above embodiment is shown.

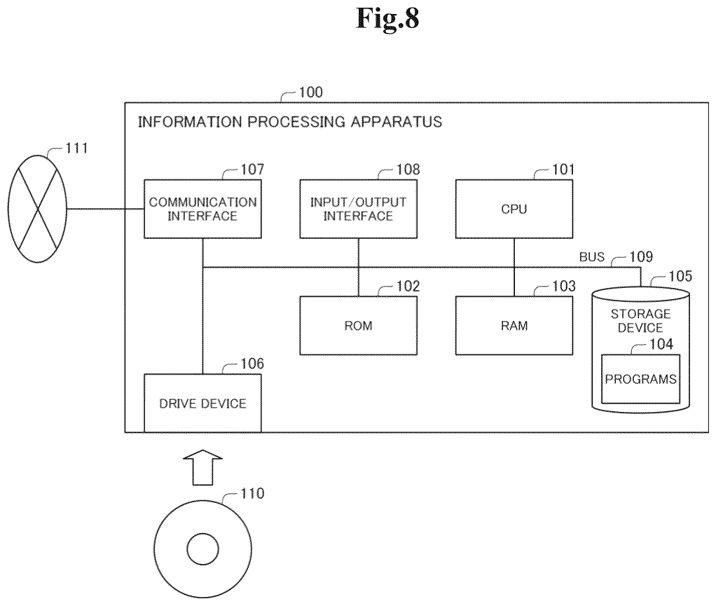

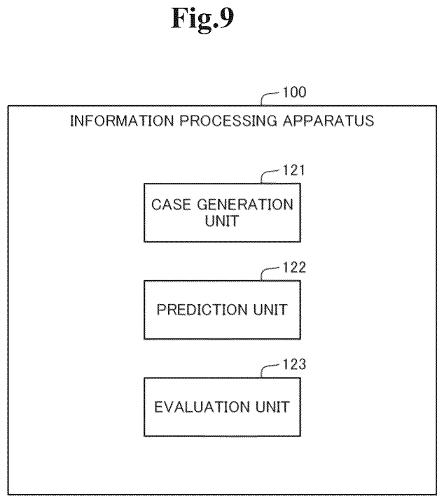

As illustrated in FIG. 8, an information processing apparatus 100 in the present embodiment is configured of a general information processing apparatus, and is equipped with, as an example, the following hardware configuration.
a CPU (Central Processing Unit) 101 (arithmetic logic unit);
a ROM (Read Only Memory) 102 (memory unit);
a RAM (Random Access Memory) 103 (memory unit);
programs 104 to be loaded into the RAM 103;
a storage device 105 storing the programs 104;
a drive device 106 that performs reading from and writing into a storage medium 110 external to the information processing apparatus;
a communication interface 107 connected to a communication network 111 external to the information processing apparatus;
an input/output interface 108 that performs input/output of data; and
a bus 109 connecting the components.

Note that FIG. 8 illustrates an example of the hardware configuration of an information processing apparatus that is the information processing apparatus device 100, and the hardware configuration of the information processing apparatus is not limited to the above example. For example, the information processing apparatus may be configured of part of the abovementioned configuration, such as not having the drive device 106. Moreover, the information processing apparatus may use a GPU (Graphic Processing Unit), a DSP (Digital Signal Processor), an MPU (Micro Processing Unit), an FPU (Floating point number Processing Unit), a PPU (Physics Processing Unit), a TPU (Tensor Processing Unit), a quantum processor, a microcontroller, or a combination of these, instead of the abovementioned CPU.

The information processing apparatus 100 can construct and include a case generation unit 121, a prediction unit 122, and an evaluation unit 123 illustrated in FIG. 9 by the CPU 101 acquiring and executing the programs 104. The programs 104 are, for example, stored in advance in the storage device 105 or the ROM 102, and are loaded into the RAM 103 and executed by the CPU 101 as necessary. In addition, the programs 104 may be provided to the CPU 101 via the communication network 111, or may be stored in advance in the storage medium 110 and read out by the drive device 106 and provided to the CPU 101. However, the case generation unit 121, the prediction unit 122, and the evaluation unit 123 mentioned above may be constructed as dedicated electronic circuits to implement such means.

The case generation unit 121 generates a virtual case so as to satisfy constraints set in advance for some of the attributes included in the case. The prediction unit 122 performs preset prediction for the virtual case. The evaluation unit 123 evaluates conditions set for attributes different from the attributes applicable to the constraints included in the virtual case on the basis of the prediction for the virtual case. At this time, the evaluation unit 123 calculates a preset statistical quantity of the prediction for the virtual case that includes the attributes applicable to the conditions, and evaluates the conditions based on the statistical quantity. In addition, the evaluation unit 123 further uses the ratio satisfying the conditions of the virtual cases to evaluate the conditions.

Since the present disclosure is configured as described above, a virtual case that satisfies the constraints is generated, and the conditions of such a virtual case are evaluated according to the prediction for the virtual case. Therefore, it is possible to improve the reliability of the case corresponding to the evaluated conditions and to make effective use of the prediction model.

At least one or more of the functions of the case generation unit 121, the prediction unit 122, and the evaluation unit 123 described above may be executed by an information processing apparatus installed and connected at any location on the network, that is to say, they may be executed by so-called cloud computing.

The aforementioned program can be stored using various types of non-transitory computer-readable media and provided to a computer. The non-transitory computer-readable media include various types of tangible storage media. Examples of non-transitory computer-readable media include a magnetic recording medium (e.g., flexible disk, magnetic tape, hard disk drive), a magneto-optical recording medium (e.g., magneto-optical disk), a read only memory (CD-ROM), a CD-R, a CD-R/W, and a semiconductor memory (e.g., mask ROM, programmable ROM, Erasable PROM, flash ROM, random access memory (RAM)). In addition, a program may be provided to a computer by various types of transitory computer-readable media. Examples of transitory computer-readable media include electrical signals, optical signals, and electromagnetic waves. The transitory computer-readable medium may provide a program to the computer via a wired communication channel such as an electric wire and an optical fiber, or a wireless communication channel.

Although the present disclosure has been described above with reference to the above-described example embodiments, the present disclosure is not limited to the example embodiments described above. The configuration and details of the present disclosure can be changed in a variety of ways that those skilled in the art can understand within the scope of the present disclosure. Furthermore, the above described embodiments can be combined as appropriate with other embodiments.

### SUPPLEMENTARY NOTES

The whole or part of the example embodiments disclosed above can be described as the following supplementary notes. Hereinafter, the overview of the configurations of the information processing apparatus, the information processing method, and the program in the present disclosure will be described. However, the present disclosure is not limited to the following configurations.

### Supplementary Note 1

An information processing apparatus comprising:
a case generation unit that generates a virtual case so as to satisfy a constraint set in advance for a part of attributes included in a case;
a prediction unit that performs prediction set in advance for the virtual case; and
an evaluation unit that evaluates a condition set for an attribute different from the part of the attributes applicable to the constraint included in the virtual case, on a basis of the prediction for the virtual case.

### Supplementary Note 2

The information processing apparatus according to supplementary note 1, wherein
the evaluation unit evaluates the condition on the basis of the prediction for the virtual case including the attribute applicable to the condition.

### Supplementary Note 3

The information processing apparatus according to supplementary note 2, wherein
the evaluation unit calculates a statistical quantity, set in advance, of the prediction for the virtual case that includes the attribute applicable to the condition, and evaluates the condition on a basis of the statistical quantity.

### Supplementary Note 4

The information processing apparatus according to supplementary note 3, wherein
when the prediction is output with a probability in which a desired result is obtainable, the evaluation unit evaluates the condition higher as the statistic quantity is higher.

### Supplementary Note 5

The information processing apparatus according to supplementary note 1, wherein
the evaluation unit evaluates the condition by further using a ratio of the virtual cases satisfying the condition.

### Supplementary Note 6

The information processing apparatus according to supplementary note 5, wherein
the evaluation unit evaluates the condition higher as the ratio is higher.

### Supplementary Note 7

The information processing apparatus according to supplementary note 4, wherein
the evaluation unit evaluates the condition higher as the ratio of the virtual cases satisfying the condition and the statistical quantity are higher.

### Supplementary Note 8

The information processing apparatus according to supplementary note 7, further comprising
a condition generation unit that generates a new condition so that either the ratio of the virtual cases satisfying the condition or the statistical quantity increases.

### Supplementary Note 9

The information processing apparatus according to supplementary note 1, wherein
when values of one or more explanatory variables are set, the case generation unit generates the virtual case by using a machine learning model trained in advance so as to generate a value of another explanatory variable.

### Supplementary Note 10

An information processing method comprising:
generating a virtual case so as to satisfy a constraint set in advance for a part of attributes included in a case;
performing prediction set in advance for the virtual case; and
evaluating a condition set for an attribute different from the part of the attributes applicable to the constraint included in the virtual case, on a basis of the prediction for the virtual case.

### Supplementary Note 11

The information processing method according to supplementary note 10, further comprising
evaluating the condition on the basis of the prediction for the virtual case including the attribute applicable to the condition.

### Supplementary Note 12

The information processing method according to supplementary note 11, further comprising
calculating a statistical quantity, set in advance, of the prediction for the virtual case that includes the attribute applicable to the condition, and evaluating the condition on a basis of the statistical quantity.

### Supplementary Note 13

The information processing method according to supplementary note 10, further comprising
evaluating the condition by further using a ratio of the virtual cases satisfying the condition.

### Supplementary Note 14

A computer-readable medium storing thereon a program for causing a computer to execute processing to:
generate a virtual case so as to satisfy a constraint set in advance for a part of attributes included in a case;
perform prediction set in advance for the virtual case; and
evaluate a condition set for an attribute different from the part of the attributes applicable to the constraint included in the virtual case, on a basis of the prediction for the virtual case.

### REFERENCE SIGNS LIST

10 information processing apparatus
11 input unit
12 virtual case generation unit
13 prediction unit
14 condition evaluation unit
15 condition output unit
16 model storing unit
17 case storing unit
100 information processing apparatus
101 CPU
102 ROM
103 RAM
104 programs
105 storage device
106 drive device
107 communication interface
108 input/output interface
109 bus
110 storage medium
111 communication network
121 case generation unit
122 prediction unit
123 evaluation unit

What is claimed is:

1. An information processing apparatus comprising:
at least one memory configured to store instructions; and
at least one processor configured to execute instructions to;
generate a virtual case so as to satisfy a constraint set in advance for a part of attributes included in a case;
perform prediction set in advance for the virtual case; and
evaluate a condition set for an attribute different from the part of the attributes applicable to the constraint included in the virtual case, on a basis of the prediction for the virtual case.

2. The information processing apparatus according to claim 1, wherein the at least one processor is configured to execute the instructions to
evaluate the condition on the basis of the prediction for the virtual case including the attribute applicable to the condition.

3. The information processing apparatus according to claim 2, wherein the at least one processor is configured to execute the instructions to
calculate a statistical quantity, set in advance, of the prediction for the virtual case that includes the attribute applicable to the condition, and evaluate the condition on a basis of the statistical quantity.

4. The information processing apparatus according to claim 3, wherein the at least one processor is configured to execute the instructions to,
when the prediction is output with a probability in which a desired result is obtainable, evaluate the condition higher as the statistic quantity is higher.

5. The information processing apparatus according to claim 1, wherein the at least one processor is configured to execute the instructions to
evaluate the condition by further using a ratio of the virtual cases satisfying the condition.

6. The information processing apparatus according to claim 5, wherein the at least one processor is configured to execute the instructions to
evaluate the condition higher as the ratio is higher.

7. The information processing apparatus according to claim 4, wherein the at least one processor is configured to execute the instructions to
evaluate the condition higher as the ratio of the virtual cases satisfying the condition and the statistical quantity are higher.

8. The information processing apparatus according to claim 7, wherein the at least one processor is configured to execute the instructions to
generate a new condition so that either the ratio of the virtual cases satisfying the condition or the statistical quantity increases.

9. The information processing apparatus according to claim 1, wherein the at least one processor is configured to execute the instructions to,
when values of one or more explanatory variables are set, generate the virtual case by using a machine learning model trained in advance so as to generate a value of another explanatory variable.

10. An information processing method comprising:
generating a virtual case so as to satisfy a constraint set in advance for a part of attributes included in a case;
performing prediction set in advance for the virtual case; and
evaluating a condition set for an attribute different from the part of the attributes applicable to the constraint included in the virtual case, on a basis of the prediction for the virtual case.

11. The information processing method according to claim 10, further comprising
evaluating the condition on the basis of the prediction for the virtual case including the attribute applicable to the condition.

12. The information processing method according to claim 11, further comprising
calculating a statistical quantity, set in advance, of the prediction for the virtual case that includes the attribute applicable to the condition, and evaluating the condition on a basis of the statistical quantity.

13. The information processing method according to claim 10, further comprising
evaluating the condition by further using a ratio of the virtual cases satisfying the condition.

14. A non-transitory computer-readable medium storing thereon a program comprising instructions for causing a computer to execute processing to:
generate a virtual case so as to satisfy a constraint set in advance for a part of attributes included in a case;
perform prediction set in advance for the virtual case; and
evaluate a condition set for an attribute different from the part of the attributes applicable to the constraint included in the virtual case, on a basis of the prediction for the virtual case.

15. The information processing method according to claim 12, further comprising,
when the prediction is output with a probability in which a desired result is obtainable, evaluating the condition higher as the statistic quantity is higher.

16. The information processing method according to claim 13, further comprising
evaluating the condition higher as the ratio is higher.

17. The information processing method according to claim 15, further comprising
evaluating the condition higher as the ratio of the virtual cases satisfying the condition and the statistical quantity are higher.

18. The information processing method according to claim 17, further comprising
generating a new condition so that either the ratio of the virtual cases satisfying the condition or the statistical quantity increases.

19. The information processing method according to claim 10, further comprising,
when values of one or more explanatory variables are set, generating the virtual case by using a machine learning model trained in advance so as to generate a value of another explanatory variable.
